(19) United States
(12) Patent Application Publication
(10) Pub. No.: US 2026/0307782 A1
(43) Pub. Date: Oct. 8, 2026

(54) CONTROLLABLE APPARATUS AND CONTROL HANDLE FOR PRODUCING SUCH CONTROLLABLE APPARATUS

(71) Applicants: CROUZET, Valence (FR); SAFRAN ELECTRONICS & DEFENSE, PARIS (FR)

(72) Inventors: Hervé Carton, VALENCE (FR); Bruno Taillet, VALENCE (FR); Albert Auphan, PARIS (FR); Yannick Ghislain Attrazic, PARIS (FR); Pascal Gaden, PARIS (FR)

(21) Appl. No.: 19/136,856

(22) PCT Filed: Nov. 16, 2023
(86) PCT No.: PCT/EP2023/082081

§ 371 Date: Jun. 6, 2025

(30) Foreign Application Priority Data
Dec. 7, 2022 (FR) FR2212885

(51) Int. Cl. B64C 13/04; G05G 9/047

(52) U.S. Cl. CPC B64C 13/042; G05G 9/047; G05G 2009/04774

(57) ABSTRACT

A device includes a control handle having several detection zones. Each detection zone includes a first and a second sensor, each capable of switching to an active state when it detects the presence of the pilot's hand on the detection zone. These first and second sensors are sensitive to, respectively, a first and a second physical characteristic of the pilot's hand, the second physical characteristic being independent of the first physical characteristic. A processing unit of the device is configured to calculate the number of detection zones that have at least one sensor in the active state, and, when this calculated number is greater than a predetermined threshold, to trigger the indication of a correct grip of the handle.

### CROSS-REFERENCE TO RELATED APPLICATIONS

This application is a national phase entry under 35 U.S.C. § 371 of International Patent Application PCT/EP2023/082081, filed Nov. 16, 2023, designating the United States of America and published as International Patent Publication WO 2024/120786 A1 on Jun. 13, 2024, which claims the benefit, under Article 8 of the Patent Cooperation Treaty, of French Patent Application Serial No. FR2212885, filed Dec. 7, 2022.

### TECHNICAL FIELD

The present disclosure concerns a controllable device and a control handle for realizing this controllable device.

### BACKGROUND

U.S. Pat. No. 6,948,398 describes a vehicle that can be driven using a control handle. This handle has two detection zones arranged at points on the handle, which enable a correct grip of the handle by a pilot's hand to be detected. Only when the handle is gripped correctly can it be switched from a deactivated state to an activated state. In the deactivated state, the handle cannot be used to drive the vehicle. In the activated state, the handle can be used to drive the vehicle.

The grip is correct only if the pilot's hand presses simultaneously on both detection zones. Conversely, if the pilot's hand presses only one or neither of the two detection zones, the grip is incorrect and the handle remains in its deactivated state.

To detect the presence of the hand on each of the detection zones, each of these detection zones is equipped with a capacitive sensor capable of reversibly switching between:
an active state in which it detects the presence of the pilot's hand on this detection zone; and, alternately,
in an idle state in which it does not detect the presence of the pilot's hand on the detection zone.

This vehicle equipped with this handle is advantageous in that it prevents driving errors. In particular, in the deactivated state, accidental movement of the handle, such as a knee blow to the handle, cannot cause accidental, involuntary movement of the vehicle.

U.S. Pat. No. 6,948,398 also states that the use of capacitive sensors is advantageous because it enables the detection of a correct grip on the handle even when the pilot is wearing gloves. In practice, however, this is not always true, as there are gloves made of dielectric materials, which, when worn by the pilot, make it impossible to detect the hand resting on the two detection zones. In such a case, the handle remains in its deactivated state. This prevents the vehicle from being driven even though the handle is correctly gripped. Such a situation is subsequently referred to as a “false “negative,” because an incorrect grip is detected when, in reality, the grip is correct.

Prior art is also known from U.S. Pat. No. 6,948,398B2, FR3117997A1 and US2008/250889A1.

### BRIEF SUMMARY

Embodiments of the present disclosure aim to remedy the above-mentioned drawback by providing a handle-controlled device in which the occurrence of false negatives is limited.

The object is therefore a controllable device as claimed in the first independent claim.

The present disclosure also relates to a control handle for the realization of this controllable device.

### BRIEF DESCRIPTION OF THE DRAWINGS

Embodiments of the present disclosure will be better understood on reading the following description, given only as a non-limiting example and made with reference to the drawings of which:

FIG. 1 is a schematic illustration of the architecture of a device that can be controlled using a control handle;

FIG. 2 is a schematic illustration, in front view, of the control handle of the device shown in FIG. 1;

FIG. 3 is a schematic illustration, in rear view, of the control handle of the device shown in FIG. 1; and

FIG. 4 is a schematic illustration of a detection zone on the control handle of the device shown in FIG. 1.

In these figures, the same references are used to designate the same elements.

### DETAILED DESCRIPTION

In this description, a detailed example of an embodiment is first described in Chapter I with reference to the figures. Then, in Chapter II, variants of this embodiment are presented. Finally, the advantages of the various embodiments are explained in Chapter III. In the remainder of this description, features and functions well known to the skilled person are not described in detail.

### Chapter I: Example of Embodiments

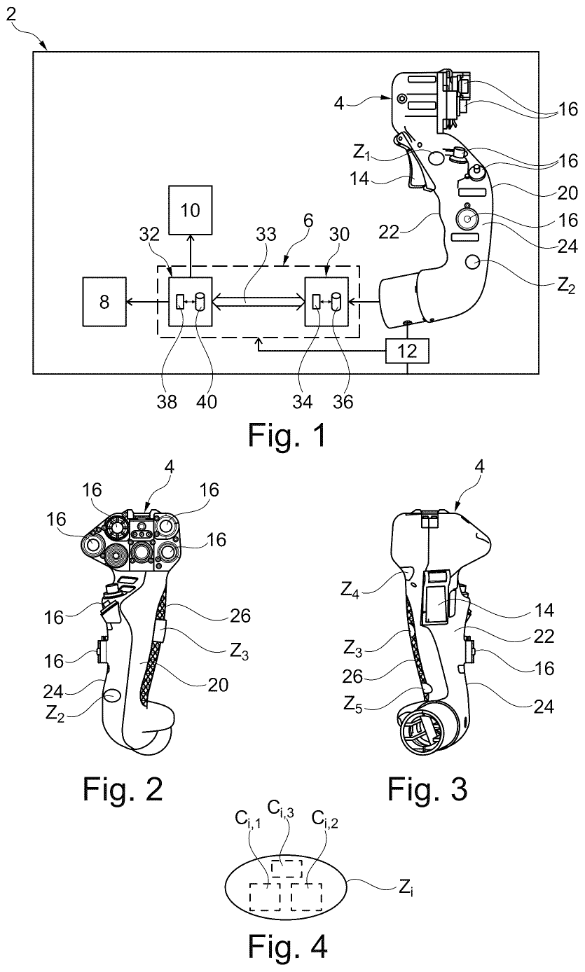

FIG. 1 shows a device 2 that can be controlled using a handle 4. Here, by way of illustration, the device 2 is an aircraft, such as a plane or helicopter. The device 2 comprises:
a unit 6 for processing the various items of information obtained in response to actuation of handle 4 by a pilot's hand, and
one or more electric actuators that receive control commands sent by the processing unit 6 in response to the actions of the pilot's hand on the handle 4.

To simplify FIG. 1, only two actuators 8 and 10 are shown. For example, actuator 8 is an electric actuator of the propulsion and guidance means of device 2. By way of illustration, actuator 8 is used to adjust the speed of device 2 or the direction in which device 2 moves.

Actuator 10 is an actuator independent of the propulsion and guidance means of device 2. For example, actuator 10 is used to trigger an action such as firing a projectile. The projectile is, for example, a missile or a bullet.

Here, the handle 4 is a handle that can be moved relative to the chassis of the device 2 by the pilot's hand. For example, handle 4 can be rotated about a longitudinal axis and about a transverse axis. Typically, the longitudinal axis is parallel to the direction of travel of the device 2 when it is moving in a straight line. The transverse axis is perpendicular to the longitudinal axis and lies in a horizontal plane when the device is moving horizontally.

To measure the angles of rotation of the handle 4 about the longitudinal and transverse axes, the device 2 is equipped with at least one unit 12 for measuring the displacements of the handle 4 relative to the chassis of device 2. Unit 12 transmits the measured angles to processing unit 6.

In this example, handle 4 is also equipped with several buttons that can be operated by the pilot's fingers. Each button is reversibly movable between a released and a depressed position. It is the pilot's finger that moves any of these buttons from its released position to its depressed position against a return force. In the absence of any external force, each button is in its released position. When a button is moved from its released position to its depressed position, a control command is sent to an electrical actuator on device 2. For example, here, pressing at least one of these buttons is likely to trigger the sending of a command to drive actuator 10, which fires a projectile. This button bears the numerical reference 14 on FIG. 1 and takes the form of a trigger.

To simplify the figures, the other buttons on handle 4 are each designated by the numerical reference 16, even though the structures of these other buttons may be different and the actions triggered by pressing each of these buttons 16 are different.

Each of these buttons 14, 16 is connected to the processing unit 6, so that the unit 6 can acquire the position in which each of these buttons is placed.

Hereinafter, the term “handle actuation” refers both to moving the handle 4 and to pressing one of the buttons on handle 4.

Between buttons 14 and 16, handle 4 has gripping surfaces on which the pilot's hand rests when the handle 4 is gripped correctly. The location of these surfaces coincides with typical contact zones between the pilot's hand and the handle. In this example, the handle 4 has the following features during normal, correct gripping of the handle 4 by the pilot:
a front gripping surface 20 facing the pilot,
a rear gripping surface 22 located on the opposite side of the gripping surface 20,
lateral gripping surfaces 24 and 26 (FIG. 2).

Lateral gripping surfaces 24 and 26 are located between gripping surfaces 20 and 22. Here, these lateral gripping surfaces 24 and 26 are located, respectively, on the left and right sides of the handle 4.

Typically, these gripping surfaces are shaped and/or made of a material that ensures the pilot's comfort when holding the handle 4 with his hand.

Within these gripping surfaces, the handle 4 comprises detection zones Zᵢ, where the index “i” is an identifier of the detection zone Zᵢ among the various detection zones of the handle 4. These detection zones Zᵢ are arranged on the gripping surfaces at locations that allow detection of a correct grip of the handle 4 by the pilot's hand. Typically, these are places where the palm and/or fingers of the pilot's hand are located when the grip of the handle 4 is correct. These locations vary according to the shape of the handle. Thus, the location of these detection zones Zᵢ must be determined on a case-by-case basis according to the shape of the handle.

Typically, to detect a correct grip of the handle 4, the detection zones Zᵢ are arranged at least within two gripping surfaces located on opposite sides of the handle 4. For this purpose, here, detection zones Zᵢ are arranged in each of the gripping surfaces 20, 22, 24 and 26.

Preferably, the number N_{z} of detection zones is odd and equal to 2M+1, where M is an integer greater than or equal to one and preferably greater than or equal to two or three. In this embodiment, the number M is equal to two and the handle 4 has five detection zones Z₁ to Z₅.

Examples of where these five zones Zᵢ are arranged are shown in FIGS. 1 to 3. In FIG. 1, the handle 4 is shown in side view. In FIGS. 2 and 3, the handle 4 is shown in front and rear view respectively. Here, when the grip of handle 4 is correct:
the zone Z₁ is located under the thumb of the hand,
the zone Z₂ is located under the little finger of the hand,
the zone Z₃ is located under the top of the palm of the hand,
the zone Z₄ is located under the index finger of the hand, and
the zone Z₅ is located under the bottom of the palm of the hand.

To enable detection, each of these zones Zᵢ comprises two sensors, C_{i,1} and C_{i,2}, respectively, (FIG. 4). Each of these sensors is able to switch reversibly between:
an active state in which it detects the presence of the pilot's hand on the detection zone Zᵢ; and, alternately,
an idle state in which the presence of the pilot's hand on the detection zone Zᵢ is not detected.

Each of the sensors C_{i,1} and C_{i,2} in the zone Zᵢ is insensitive to the presence and absence of the pilot's hand in a detection zone other than the detection zone Zᵢ. These sensors are separate from the buttons 14, 16 and operate independently of the buttons 14, 16. In particular, the switching of a sensor between its idle state and its active state does not, in itself, cause the generation of a control command. Here, the sensors are only used to detect whether the handle 4 is correctly gripped.

Each of the sensors C_{i,1} and C_{i,2} in each zone Zᵢ is connected to the processing unit 6. Thus, this processing unit 6 can also acquire the current state of each of the sensors C_{i,1} and C_{i,2} at a given time.

An example of a zone Zᵢ is described in more detail with reference to FIG. 4.

In this embodiment, the processing unit 6 comprises an electronic computer 30 integrated inside the handle 4 and a central electronic computer 32 (also referred to herein as a “central computer” 32) located outside the handle 4. To improve legibility in FIG. 1, the computer 30 has been shown next to the handle 4.

The computer 30 and the central computer 32 are connected to each other by an information transmission link 33, such as a wired connection.

The computer 30 is configured:
to acquire the state of each sensor C_{i,1} and C_{i,2} in each zone Zᵢ, then
depending on the state of these sensors C_{i,1} and C_{i,2}, to detect and signal a correct grip of handle 4 by the pilot's hand.

As explained in the introduction to the present disclosure, a “correct” grip of the handle 4 is a grip that switches the handle 4 from a deactivated state to an activated state. This state is managed by the central computer 32 to take into account or not the handle movement information. In this embodiment, in the deactivated state, regardless of the actuation of handle 4, no command to drive an actuator of device 2 is transmitted by processing unit 6 to the actuator or actuators concerned. In other words, in the deactivated state, handle 4 cannot be used to drive device 2. Conversely, in the activated state, in response to each actuation of the handle 4, a corresponding control command is transmitted to the actuator or actuators concerned. Thus, it is only in its activated state that handle 4 can be used to drive device 2. As a result, the device 2 can only be controlled by the handle 4 if it is correctly gripped by the pilot.

The correct grip is also a grip of the handle that cannot be mistaken for an accidental impact on the handle 4. Thus, a correct grip corresponds to simultaneous presses on several of the detection zones Zᵢ and, preferably, on at least three or more detection zones Zᵢ of the handle 4. To this end, here, the computer 30 is configured to perform the following operations at a frequency greater than 1 Hz, and, in particular, greater than 10 Hz:
Operation 1): Calculate the number N_{A} of zones Zᵢ containing at least one sensor C_{i,1} or C_{i,2} in its active state, then
Operation 2): Check whether the following condition (1) is satisfied: N_{A}≥S₁, where S₁ is a predetermined threshold, then
Operation 3): If condition (1) is satisfied, trigger an indication of correct grip; if condition (1) is not satisfied, do not trigger the indication of the correct grip.

Hereafter, in this text, when a zone Zᵢ has at least one sensor in its active state, this zone Zᵢ is said to be “switched on.” Conversely, if this zone Zᵢ comprises only sensors in their idle state, this zone Zᵢ is said to be “switched off.”

Preferably, the threshold S₁ is chosen to be greater than or equal to the number M. Furthermore, here the threshold S₁ is chosen to be less than the total number N_{Z} of zones Zᵢ. In this way, it is not necessary for the pilot's hand to be resting on each of the zones Zᵢ for the grip to be correct. This allows tolerance to variations in the correct grip of handle 4 inherent in intra-and inter-individual variations in the user population.

Here, the threshold S₁ is chosen equal to M+1, i.e., equal to three in this example.

To implement operations 1) to 3) above, the computer 30 comprises a computing core, such as a microprocessor 34, and a memory 36. Memory 36 contains the instructions executable by microprocessor 34, required to perform operations 1) to 3) above.

The central computer 32 acquires the correct grip indication transmitted by the computer 30. In response, if handle 4 is in its deactivated state, it immediately switches the state of handle 4 from deactivated to activated. The state of handle 4 is typically recorded in a variable stored in the central computer 32. Thus, the expression “handle 4 is in its activated state” means only that the value of this variable is equal to a first predefined value. The expression “handle 4 is in its deactivated state” means that the value of this same variable is equal to a second, different predefined value.

As long as handle 4 is in the activated state, at a frequency greater than 1 Hz or 10 Hz, central computer 32 performs the following operations:
Operation (a): central computer 32 acquires the measurements of unit 12 and the position of buttons 14 and 16 on the handle, then
Operation (b): The central computer 32 generates actuator control commands as a function of the measurements and positions acquired in operation (a), then
Operation (c): central computer 32 sends the control commands generated in operation (b) to the actuators concerned.

Thus, as long as the handle 4 is in the activated state, the central computer 32 transforms each actuation of the handle 4 into control commands for one or more of the device 2 actuators, depending on the action performed by the pilot's hand on the handle 4.

For example, central computer 32 can:
send a command to drive actuator 8 based on the angles measured by unit 12, and
send a drive command to actuator 10 when button 14 reaches its depressed position.

As long as handle 4 is in its activated state, central computer 32 also checks at regular intervals whether a condition (2) is satisfied. When condition (2) is satisfied, the central computer 32 immediately switches the state of handle 4 from activated to deactivated. For example, here condition (2) is that for a predetermined period of time, the central computer 32 receives no indication of a correct grip.

As long as the handle 4 is in the deactivated state, the central computer 32 inhibits the sending, to the actuators of the device 2, of any control command generated as a function of a movement of the handle 4 or in response to the pressing of a button 14, 16 on the handle 4. Thus, in this example, to control the device 2 using the handle 4, the grip of the handle 4 must be correct.

Typically, the central computer 32 comprises a microprocessor 38 capable of executing instructions and a memory 40. The memory 40 contains the instructions and data required to execute the various operations described above.

FIG. 4 shows a detection zone Zᵢ and its two sensors C_{i,1} and C_{i,2}. Sensors C_{i,1} and C_{i,2} are sensitive, respectively, to a first and a second physical characteristic of the pilot's hand to detect its presence and, alternately, its absence on the detection zone Zᵢ.

The use of different sensor technologies makes it possible to address different issues: a first issue of common mode failure, and a second issue of operational detection conditions.

A common mode failure is the simultaneous failure of all sensors due to a single cause. Using sensors of different technologies for the same detection zone, i.e., sensitive to different physical characteristics, provides an advantageous solution to this problem.

For aspects of the operational detection condition, the use of sensors of different physical characteristics makes it possible to deal with the case where sensor C_{i,1} is inoperative, while sensor C_{i,2} remains operational, when the handle 4 is used in a particular context. In this text, when a sensor is “inoperative,” this means that it is unable to switch to its active state even if the pilot's hand is present on the zone Zᵢ. In the opposite case, i.e., when the sensor is able to switch to its active state if the pilot's hand is present on zone Zᵢ, it is said to be “operational.” In this text, sensor C_{i,2} is said to be “complementary” to sensor C_{i,1}, as it is operational in a particular context of use where sensor C_{i,1} is inoperative. In this way, sensor C_{i,2} compensates for a functional limitation of sensor C_{i,1} in a particular context of use of handle 4. Such a functional limitation of sensor C_{i,1} is not a failure of sensor C_{i,1}, because as soon as the particular context of use disappears, sensor C_{i,1} is immediately operational again. A particular context of use is a context of use likely to be encountered, generally rarely, during normal use of the handle 4.

For example, here, sensor C_{i,1} is a sensor sensitive to the electrical conductivity of human skin. In this case, the particular context in which sensor C_{i,1} is inoperative is when the pilot is wearing gloves made of dielectric material. In this particular context, sensor C_{i,1} is unable to switch to its active state even if the gloved hand is present on zone Zᵢ.

In this case, since the sensor C_{i,2} uses a physical characteristic of the hand other than its electrical conductivity, this sensor C_{i,2} remains operational when the gloved hand is present over the zone Zᵢ. Consequently, the fact that the pilot is wearing gloves made of dielectric material does not prevent the zone Zᵢ from switching on correctly when the pilot's hand is present on this detection zone. As a result, a correct grip can also be detected, even in this particular context.

For example, here the second physical characteristic of the pilot's hand is its ability to reflect radiation. The sensor C_{i,2} is a proximity sensor that emits radiation, for example infrared radiation, and detects the radiation reflected by the hand when it rests on the sensor C_{i,2} or is very close to the sensor C_{i,2}. For example, “very close” means less than 1 mm away. Typically, the radiation emitted by the sensor C_{i,2} is modulated with information to distinguish it from other infrared radiation sources in the vicinity of the sensor C_{i,2}.

Each of the sensors C_{i,1} and C_{i,2} has a sensitive face. The sensitive face of a sensor on handle 4 is the portion of the gripping surface:
inside which this sensor is able to detect the presence of the hand, and
beyond which the same sensor is no longer able to detect the presence of the hand.

In this first embodiment, the intersection of the sensitive faces of the sensors C_{i,1} and C_{i,2} has an area greater than 0 cm², and preferably greater than 0.5 cm² or 1 cm². Preferably, the area of the intersection is greater than 0.8 Sₘₐₓ or 0.9 Sₘₐₓ, where Sₘₐₓ is the area of the largest of the sensitive faces of the sensors C_{i,1} and C_{i,2}. For this purpose, the sensitive faces of the sensors C_{i,1} and C_{i,2} are almost or are merged, or the sensitive face of one of the sensors C_{i,1} and C_{i,2} is completely enclosed within the sensitive face of the other of the sensors C_{i,1} and C_{i,2}.

The detection zone Zᵢ is the area of smallest surface area that completely contains the sensitive faces of the sensors C_{i,1} and C_{i,2}.

### Chapter II: Variants

### Handle Variants

Alternatively, the handle comprises an additional complementary sensor C_{i,3} (FIG. 4). Sensor C_{i,3} uses a physical characteristic of the pilot's hand to detect its presence on zone Zᵢ that is different from the first and second physical characteristics used, respectively, by sensors C_{i,1} and C_{i,2}. For example, sensor C_{i,3} is a sensor directly sensitive to the force with which the pilot's hand presses against the zone Zᵢ. By way of illustration, sensor C_{i,3} is a piezoelectric sensor or similar that switches to its active state if the pressure exerted by the pilot's hand on zone Zᵢ exceeds a predetermined threshold S₃. At least one of the zones Zᵢ comprises this additional sensor C_{i,3}. The sensor C_{i,3} can be integrated into the zone Zᵢ in addition to the sensors C_{i,1} and C_{i,2}. In this case, the zone Zᵢ comprises three sensors C_{i,1}, C_{i,2} and C_{i,3}. This detection zone Zᵢ is then switched on as soon as at least one of the sensors C_{i,1}, C_{i,2} and C_{i,3} is in the active state. In this variant, each zone Zᵢ preferably comprises a sensor C_{i,3}.

Sensor C_{i,3} can also be integrated into the zone Zᵢ, replacing one of the two sensors C_{i,1} and C_{i,2}. In this case, the number of sensors in zone Zᵢ remains equal to two. For example, if sensor C_{i,3} replaces sensor C_{i,2}, zone Zᵢ is switched on as soon as at least one of sensors C_{i,1} and C_{i,3} switches to its active state. In this variant, only some of the zones Zᵢ comprise the sensor C_{i,3}.

In addition to the sensors C_{i,1}, C_{i,2} and C_{i,3}, it is also possible to integrate further sensors into the handle, each of which uses a different physical characteristic of the pilot's hand to detect its presence in a zone Zᵢ. In this case, a detection zone Zᵢ may comprise more than three different sensors.

A detection zone can also comprise several sensors that are identical or sensitive to the same physical characteristic of the pilot's hand. This increases operational reliability. However, even in this case, the detection zone comprises at least one complementary sensor. For example, the zone Zᵢ comprises two copies of sensor C_{i,1} and a single copy of sensor C_{i,2}, or comprises two copies of sensor C_{i,1} and two copies of sensor C_{i,2}.

Other technologies of sensor C_{i,1} that are sensitive to the electrical conductivity of the skin are also possible. For example, alternatively, the sensor C_{i,1} is a resistive sensor rather than a capacitive sensor.

Similarly, other sensor technologies can be used to realize the complementary sensor C_{i,2}. For example, the complementary sensor can be a pressure sensor, such as a piezoresistive sensor, a temperature sensor or an optical sensor.

The teaching that the occurrence of false negatives is limited when sensor C_{i,2} is complementary to sensor C_{i,1}, i.e., sensor C_{i,2} is operational in a particular context where sensor C_{i,1} is inoperative, also applies to the case where sensor C_{i,1} is not sensitive to the electrical conductivity of the skin, but to another physical characteristic. For example, sensor C_{i,1} is, alternatively, a temperature sensor. Such a temperature sensor may be inoperative in a particular context where the outside temperature is very low. In this case, sensor C_{i,2} is chosen as a sensor sensitive to a physical characteristic of the hand that is not affected by very low outside temperatures. For example, in this case, sensor C_{i,2} is a sensor sensitive to the electrical conductivity of the skin, such as a capacitive sensor. In the same case, the sensor C_{i,2} can also be a sensor directly sensitive to the pressure exerted by the hand on the detection zone Zᵢ, such as a piezoelectric sensor.

Another example where the teaching given here is applied in the absence of a capacitive sensor is the case where the sensor C_{i,1} is an optical sensor. Such an optical sensor may be unable to detect the presence of the hand in a particular context where light is absent. In this case, a sensor C_{i,2} complementary to the C_{i,1} sensor is an infrared proximity sensor or a sensor sensitive to the temperature or electrical conductivity of the skin or to the pressure of the hand on the zone Zᵢ.

Alternatively, the total number N_{z} of detection zones Zᵢ is even. In an extremely simplified variant, the number N_{z} is equal to two.

In a simplified variant, the area of intersection between the sensitive faces of the sensors C_{i,1} and C_{i,2} is less than 0.8 Sₘₐₓ.

In another variant, the sensitive faces of sensors C_{i,1} and C_{i,2} do not overlap. In this case, sensors C_{i,1} and C_{i,2} are still in close proximity to each other. Here, sensors C_{i,1} and C_{i,2} are considered to be in proximity to each other if the distance between the isobarycenter of the sensitive face of sensor C_{i,1} and the isobarycenter of the sensitive face of sensor C_{i,2} is less than 30 mm and, preferably, less than 25 mm or 20 mm. In addition, sensor C_{i,2} is generally the closest sensor to sensor C_{i,1} of all the sensors on handle 4.

### Processing Unit Variants

Alternatively, the threshold value S₁ can be chosen to be less than or equal to M or greater than M+2 or M+3.

The various elements of the processing unit 6 are not necessarily distributed between the handle 4 and the external central computer 32. For example, in one variant, all the elements of the processing unit 6 are located outside the handle 4. For example, the functions performed by the computer 30 are implemented in the central computer 32, and the computer 30 is omitted. In this case, the states of the sensors C_{i,1} and C_{i,2} of the handle 4 are transmitted to the central computer 32. The central computer 32 then processes the received states to determine whether the handle 4 should be switched to its activated or deactivated state. Alternatively, the entire processing unit 6 can be housed inside the handle 4.

Alternatively, in the deactivated state, only part of the control commands that may be generated in response to actuation of handle 4 is inhibited. The other part of the commands likely to be generated in response to an actuation of handle 4, is generated even in the deactivated state of handle 4. For example, the commands likely to be generated by an actuation of handle 4, even in the deactivated state, are commands that do not call into question the safety of driving device 2.

Instead of signaling a correct grip to the central computer 32, computer 30 can signal an incorrect grip as long as condition (1) is not satisfied, and only stop signaling an incorrect grip as soon as condition (1) is satisfied. In this case, central computer 32 can deduce the existence of a correct grip from the fact that it no longer receives an indication of incorrect grip for a predetermined period of time.

Alternatively, condition (2) for switching the state of handle 4 from activated to deactivated is different. For example, alternatively, condition (2) is as follows: N_{A}≤S₂, where S₂ is a predetermined threshold. In this case, condition (2) is evaluated by the computer 30, and the computer 30 transmits an indication of incorrect grip to the central computer 32 as soon as condition (2) is satisfied. In response, the central computer 32 immediately switches the state of the handle 4 from activated to deactivated. Preferably, threshold S₂ is lower than threshold S₁, so that condition (1) for switching from the deactivated to the activated state is more difficult to satisfy and more restrictive than condition (2). This means that, once the handle 4 is in its activated state, there is greater tolerance for “losing” the grip of the handle 4 to control the device 2.

Advantageously, particularly in the field of aeronautics, the calculation core of the computer 30 is a hardware calculation unit implemented in a component such as a programmable logic circuit like an FPGA (Field Programmable Gate Array).

### Other Variants

What has been described here in the particular case of an aircraft applies to any type of vehicle, such as motor vehicles, a tank, boats or the like. It also applies to any device that can be operated using a handle, without this device necessarily being a vehicle. For example, device 2 could be a crane or a turret.

The device 2 is not necessarily a monolithic unit in which all components are attached to one another via a single chassis. Alternatively, the device 2 comprises a remote control and a device remotely controlled from this remote control. The remote control is equipped with the control handle and, for example, the processing unit 6. The actuator or actuators are mounted on the remote-controlled device. In this case, control commands are transmitted to the remote-controlled devices, typically via a wireless link. An example of such a device is the combination of a drone and its remote control.

The actuator(s) controlled as a function of handle actuation are not necessarily actuators of the device's propulsion and/or guidance means. What has been described here applies to any type of actuator controlled by way of a control handle. For example, the controlled actuator may be an actuator that controls the opening or closing of an electrical circuit.

Alternatively, the handle is fitted with one or more buttons and cannot be moved by the pilot's hand. Alternatively, the handle can have no buttons at all, and can only be moved by the pilot's hand.

When the handle can be moved by the pilot's hand, the number of degrees of freedom of movement of the handle is greater than or equal to one, and may be greater than or equal to two, three or four. In particular, in one variant, the handle can also be moved in translation and not just in rotation about one or more axes.

### Chapter III: Advantages of the Described Embodiments

The fact of grouping several complementary sensors C_{i,1} and C_{i,2} in the same detection zone Zᵢ, combined with the use of condition (1) to trigger the signaling of a correct grip, increases the reliability of the controllable device by reducing the number of occurrences of false negatives. This is illustrated in the particular case where the sensor C_{i,1} is a capacitive sensor and the pilot wears a glove made of dielectric material, so that this sensor C_{i,1} is inoperative in this context of use. In this context of use, the sensors C_{i,2}, remain able to detect the presence of the hand. In this way, each of the zones Zᵢ can be switched on, despite the fact that the pilot is wearing gloves made of dielectric material. Therefore, if the handle is correctly gripped, the number of switched-on detection zones Zᵢ exceeds the threshold S₁ and condition (1) is satisfied. In this way, the occurrence of false negatives that could occur with state-of-the-art handles is avoided.

The fact that the number of detection zones Zᵢ is odd avoids the situation of indecision that occurs, for example, when the number of switched-on zones is equal to the number of switched-off zones and the threshold S₁ is equal to N_{Z}/2. This improves the operating reliability of the controllable device.

By using at least three detection zones Zᵢ and triggering the indication of a correct grip as soon as condition (1) is satisfied, it is possible to detect several different correct grips. This is because the threshold S₁ need only be less than the total number N_{Z} of detection zones Zᵢ. By way of illustration, this can be used to detect a correct grip using a right hand as well as a left hand.

The fact that the sensitive faces of the sensors C_{i,1} and C_{i,2} are almost merged with each other improves operation of the device by limiting the number of hand positions on the handle that cause one of the sensors C_{i,1} and C_{i,2} to switch to its active state and not the other. This also results in smaller detection zones.

The fact that the sensors C_{i,1} are sensitive to the electrical conductivity of the skin, while the sensors C_{i,2} are sensitive to the proximity of the skin, makes it possible to obtain a handle that can function correctly in virtually all possible contexts of use, including particularly severe contexts of use. For example, this particular combination of complementary sensors makes it possible to obtain a handle that can be used both when the outside temperature is very low and when the pilot is wearing gloves made of dielectric material.

The fact that the detection and indication of a correct grip is carried out by the computer 30 housed in the handle 4 means that only the indication of the correct grip is transmitted to the central computer 32, and not the states of each of the sensors C_{i,1} and C_{i,2}. This reduces the amount of information transmitted over the link 33 linking the handle 4 to the central computer 32.

1. Controllable device comprising:
a control handle comprising:
a plurality of detection zones Zᵢ arranged at locations on the handle which allow detection of a correct grip of the handle by a pilot's hand, where the index i is an identifier of the detection zone Zᵢ, each of these detection zones Zᵢ being equipped for this purpose with at least one sensor capable of reversibly switching between:
an active state in which it detects the presence of the pilot's hand on the detection zone Zᵢ, and alternately
an idle state in which the presence of the pilot's hand on the detection zone Zᵢ is not detected,
each sensor in zone Zᵢ being insensitive to the presence and absence of the pilot's hand in a detection zone other than detection zone Zᵢ,
an actuator actuated in response to receipt of a control command,
a processing unit configured:
to trigger the indication of a correct grip of the handle, depending on the state of the control handle sensors,
in response to an absence of the indication of a correct grip of the control handle, to switch the handle to a deactivated state in which the sending of the control command to the actuator, in response to a movement of the handle or in response to the actuation of a button on the handle, is systematically inhibited and, alternately,
in response to an indication of the correct grip of the control handle, to switch the handle to an activated state in which, in response to a movement of the handle or in response to actuation of the button on the handle, the control command is sent to the actuator,
wherein:
each detection zone Zᵢ comprises a first and a second of the sensors each able to switch to its active state when it detects the presence on the detection zone Zᵢ of the pilot's hand, these first and second sensors of the detection zone Zᵢ being sensitive to, respectively, a first and a second physical characteristic of the pilot's hand in order to detect the presence and, alternatively, the absence of the pilot's hand on the detection zone Zᵢ, the second physical characteristic being independent of the first physical characteristic so that the second sensor is able to detect the presence of the hand on the detection zone Zᵢ in a particular context of use where the first sensor is unable to do so, and
the processing unit is configured:
to calculate the number of detection zones Zᵢ which include at least one sensor in its active state and then to check whether this calculated number is greater than a predetermined threshold, this predetermined threshold being greater than one, and
when this calculated number is greater than this predetermined threshold, to trigger the indication of the correct grip of the handle.

2. Device according to claim 1, wherein the number of detection zones Zᵢ is equal to 2M+1, where M is an integer greater than zero and the predetermined threshold is greater than or equal to M.

3. A device according to claim 1, wherein the device is a vehicle.

4. Control handle for producing a controllable device according to any one of claims 1 to 3, this control handle comprising:
a plurality of detection zones Zᵢ arranged at locations on the handle which allow detection of a correct grip of the handle by a pilot's hand, where the index i is an identifier of the detection zone Zᵢ, each of these detection zones Zᵢ being equipped for this purpose with a sensor capable of reversibly switching between:
an active state in which it detects the presence of the pilot's hand on the detection zone Zᵢ, and alternately
an idle state in which the presence of the pilot's hand on the detection zone Zᵢ is not detected,
each sensor in the zone Zᵢ being insensitive to the presence and absence of the pilot's hand in a detection zone other than the detection zone Zᵢ,
wherein each detection zone Zᵢ comprises a first and a second of the sensors each able to switch to its active state when it detects the presence on the detection zone Zᵢ of the pilot's hand, these first and second sensors of the detection zone Zᵢ being sensitive to, respectively, a first and a second physical characteristic of the pilot's hand in order to detect the presence and, alternately, the absence of the pilot's hand on the detection zone Zᵢ, the second physical characteristic being independent of the first physical characteristic so that the second sensor is able to detect the presence of the hand on the detection zone Zᵢ in a particular context of use where the first sensor is unable to do so.

5. Handle according to claim 4, wherein the handle has at least three detection zones Zᵢ arranged at locations on the handle which enable the correct grip of the handle by a pilot's hand to be detected.

6. Handle according to claim 4, wherein the first and second sensors of each detection zone Zᵢ each have a sensitive face within which the presence of the pilot's hand can be detected and outside which the presence of the pilot's hand cannot be detected, and the area of intersection between the sensitive faces of the first and second sensors is greater than 0.8 Sₘₐₓ, where Sₘₐₓ is the area of the largest of the sensitive faces of the first and second sensors.

7. Handle according to claim 4, wherein the first physical characteristic used by each first sensor of each detection zone is the electrical conductivity of the skin of the pilot's hand, and the second physical characteristic used by each second sensor of each detection zone is the ability of the pilot's hand to reflect radiation emitted by this second sensor.

8. Handle according to claim 7, wherein the first sensor is a capacitive sensor.

9. Handle according to claim 4, wherein the handle comprises an electronic computer configured:
to calculate the number of detection zones Zᵢ which include at least one sensor in its active state and then to check whether this calculated number is greater than a predetermined threshold, this predetermined threshold being greater than one, and
when this calculated number is greater than this predetermined threshold, to trigger the indication of the correct grip of the handle.

10. Handle according to claim 4, wherein the handle comprises:
at least two gripping surfaces located on opposite sides of the handle, each of these gripping surfaces corresponding to a typical contact zone between the pilot's hand and the handle, and
a detection zone Zᵢ located inside each of these gripping surfaces on opposite sides of the handle.
